(19) United States
(12) Patent Application Publication
(10) Pub. No.: US 2011/0171362 A1
(43) Pub. Date: Jul. 14, 2011

(54) Gerard's marinade for poultry and seafood

(76) Inventor: Gerard L. Reed, Santa Barbara, CA (US)

(21) Appl. No.: 12/583,556

(22) Filed: Jan. 14, 2010

(51) Int. Cl. A23L 1/221

(52) U.S. Cl. 426/650

(57) ABSTRACT

A marinade for both poultry and seafood that requires unusually rare ingredients and produces a never before flavor in each. The dry ingredients preserve and keep the color and freshness of the marinated products in tact. All the liquid ingredients and one teaspoon of each of the fifteen food additives is mixed together for up to one minute, until dissolved and kept refrigerated at forty degrees before and during marinating time of twelve to twenty four hours.

Here is my ingredients for my invention, Gerard's Marinade for Poultry and Seafood.

1 cup rhine (white) wine

1 cup vin rosa (red) wine

1 cup of pineapple juice

½ cup soy sauce

Plus the food additives of one to three to several teaspoons of any one to three to several of these food additives: Maltol, Maltodextrin, Malic Acid, Manganese chloride, Phosphoric acid, Polyisobutylene, Propyl Isobutyrate, Propyl Propionate, Tannic acid, Trehalose, Trans-3-Hexenol, Triacetyl glycerin, Ethylenediamine tetraacetic acid (EDTA) or Acacia, and or Glyceryl monostearate.

I claim:

1. A marinade comprised of unique dry and unique liquid ingredients that is equally effective in flavoring both all poultry and all seafood. Creating a marinated poultry and seafood product that is delicious, unknown to the general public and is beyond common knowledge in five precise ways:
a. red wine is only commonly used with beef.
b. rhine wine is never used with poultry or seafood because of its sour flavor. Instead, chablis and reisling wines are used because of their sweet flavors.
c. the combination of red wine and rhine wine as the main ingredients for both poultry and seafood is unheard of and never done.
d. the dry ingredients of one teaspoon of the fifteen food additives are beyond common knowledge.
e. the combination of all these unusual ingredients is never done to marinate both poultry and seafood. And it is unobvious to one having ordinary skills in the art.
